(19) United States
(12) Patent Application Publication
(10) Pub. No.: US 2020/0292863 A1
(43) Pub. Date: Sep. 17, 2020

(54) DISPLAY PANEL

(71) Applicant: Wuhan China Star Optoelectronics Technology Co., Ltd., Wuhan (CN)

(72) Inventor: Ling GAO, Wuhan (CN)

(73) Assignee: Wuhan China Star Optoelectronics Technology Co., Ltd., Wuhan (CN)

(21) Appl. No.: 16/475,686

(22) PCT Filed: Mar. 4, 2019
(86) PCT No.: PCT/CN2019/076836

§ 371 Date: Jul. 3, 2019

(30) Foreign Application Priority Data
Oct. 30, 2018 (CN) 201811279471.5

(51) Int. Cl. G02F 1/1339; G02F 1/1337; G02F 1/1335; G02F 1/1368

(52) U.S. Cl. CPC G02F 1/13394; G02F 1/1368; G02F 1/133514; G02F 1/1337

(57) ABSTRACT

A display panel includes a first substrate, a second substrate, and spacers. The second substrate is disposed opposite to the first substrate. Hollow portions are disposed on a surface of the second substrate. The spacers are disposed on the first substrate, and an end of each spacer, far from the first substrate, abuts against each hollow portion on the second substrate respectively.

### 1. FIELD OF THE DISCLOSURE

The present disclosure relates to the field of display technology, and more particularly, to a display panel.

### 2. DESCRIPTION OF THE RELATED ART

When a liquid crystal panel is under a stress test, photo spacers may slide and then damage an alignment layer on an array substrate by scratching. In general, the photo spacers are disposed under a black matrix and covered with the black matrix. However, light leakage occurs in a position that is damaged by scratching, and then spots are formed while a slidable scope of the photo spacers is greater than a sheltering scope of the black matrix. When spots occur, display quality of liquid crystal panels is crucially affected.

Therefore, it is required to provide a display panel in order to solve the above problems regarding spots.

### SUMMARY

A technical problem is that, light leakage occurs in a position that is damaged by scratching, and then spots are formed while a slidable scope of the photo spacers is greater than a sheltering scope of the black matrix. When spots occur, display quality of liquid crystal panels is crucially affected.

The object of the present disclosure is to provide a display panel to effectively improve the problems regarding spots.

In order to realize the above object, the present disclosure provides a display panel, including:

a first substrate;

a second substrate disposed opposite to the first substrate, wherein the second substrate includes an alignment layer formed on a surface of the second substrate, wherein a plurality of hollow portions are disposed on the surface of the second substrate, and wherein each of the plurality of hollow portions has an arc-shaped section; and

a plurality of spacers disposed on the first substrate, wherein an end of each of the plurality of spacers, far from the first substrate, abuts against the each of the plurality of hollow portions on the second substrate respectively.

In some embodiments, the first substrate is a color filter.

In some embodiments, the second substrate is a thin-film transistor substrate.

In order to realize the above object, the present disclosure provides a display panel, including: a first substrate; a second substrate disposed opposite to the first substrate, wherein a plurality of hollow portions are disposed on a surface of the second substrate; and a plurality of spacers disposed on the first substrate, wherein an end of each of the plurality of spacers, far from the first substrate, abuts against each of the plurality of hollow portions on the second substrate respectively.

In some embodiments, a section of the each of the plurality of hollow portions has a shape of an arc, a semicircle, a semi-ellipse, or a trapezoid.

In some embodiments, the each of the plurality of hollow portions has a ladder-shaped section.

In some embodiments, a plurality of micropores are disposed on a surface of the each of the plurality of hollow portions.

In some embodiments, the second substrate includes an alignment layer formed on the surface of the second substrate.

In some embodiments, the first substrate is a color filter.

In some embodiments, the second substrate is a thin-film transistor substrate.

In some embodiments, the second substrate further includes a planarization layer, wherein the alignment layer is formed on the planarization layer, and wherein the plurality of hollow portions are located at the upper part of the planarization layer.

In some embodiments, a depth of the each of the plurality of hollow portions is not greater than a thickness of the planarization layer.

The beneficial effect of the present disclosure is that, a display panel is provided to effectively improve the problems regarding spots.

### BRIEF DESCRIPTION OF THE DRAWINGS

To ensure the features and the technical content of the disclosure are more apparent and easier to understand, please refer to the explanation and the accompanying drawings of the disclosure as follows. However, the accompanying drawings are merely for reference without limiting the disclosure.

FIG. 1 is a cross-sectional view of a display panel according to a first embodiment of the present disclosure.

FIG. 2A is a partially cross-sectional view of a display panel according to a second embodiment of the present disclosure.

FIG. 2B is a partially cross-sectional view of a display panel according to a third embodiment of the present disclosure.

FIG. 2C is a partially cross-sectional view of a display panel according to a fourth embodiment of the present disclosure.

### DETAILED DESCRIPTION OF THE EMBODIMENTS

To ensure the objects, the technical solutions, and the effects of the disclosure are clearer and more specific, the disclosure will be explained in conjunction with the accompanying drawings in detail further below. It should be understood that the embodiments described herein are merely a part of the embodiments of the present disclosure instead of all of the embodiments and not used to limit the disclosure.

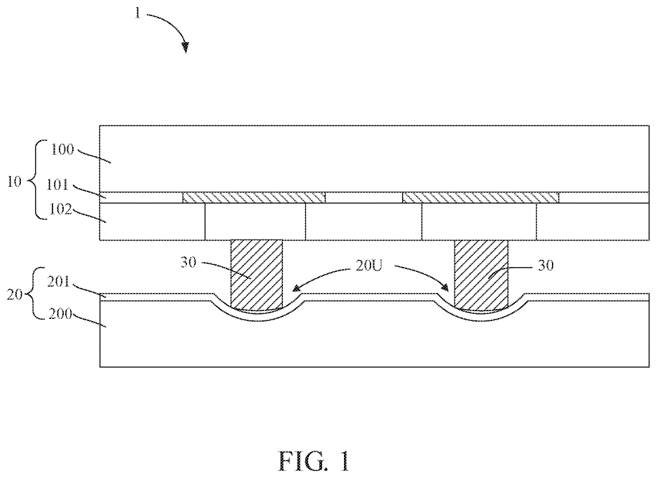

Please refer to FIG. 1, which is a cross-sectional view of a display panel according to a first embodiment of the present disclosure. A display panel 1 includes a first substrate 10, a second substrate 20, and a plurality of spacers 30. The first substrate 10 includes a transparent substrate 100, a light-shielding layer 101, and a plurality of sub-pixel areas 102 formed on the light-shielding layer 101. In an embodiment of the present disclosure, the first substrate 10 is a color filter.

As shown in FIG. 1, the second substrate 20 is disposed opposite to the first substrate 10, and a plurality of hollow portions 20U are disposed on a surface of the second substrate 20. Specifically, a section of each hollow portion 20U has, without limitation, a shape of an arc. Also, a section of each hollow portion 20U can have a shape of a semicircle or a semi-ellipse. In an embodiment of the present disclosure, the second substrate 20 includes a transparent substrate 200 and an alignment layer 201 formed on the surface of the second substrate 20. Furthermore, the second substrate 20 is a thin-film transistor substrate. In some embodiments, the second substrate 20 further includes a planarization layer. The alignment layer 201 can be formed on the planarization layer, and the plurality of hollow portions 20U are located at the upper part of the planarization layer. Specifically, a depth of each hollow portion 20U is not greater than a thickness of the planarization layer.

Continuing to refer to FIG. 1, a plurality of spacers 30 are disposed on the first substrate 10. An end of each spacer 30, far from the first substrate 10, abuts against each hollow portion 20U on the second substrate 20 respectively so that each spacer 30 can be located in a position of each hollow portion 20U on the second substrate 20 without sliding.

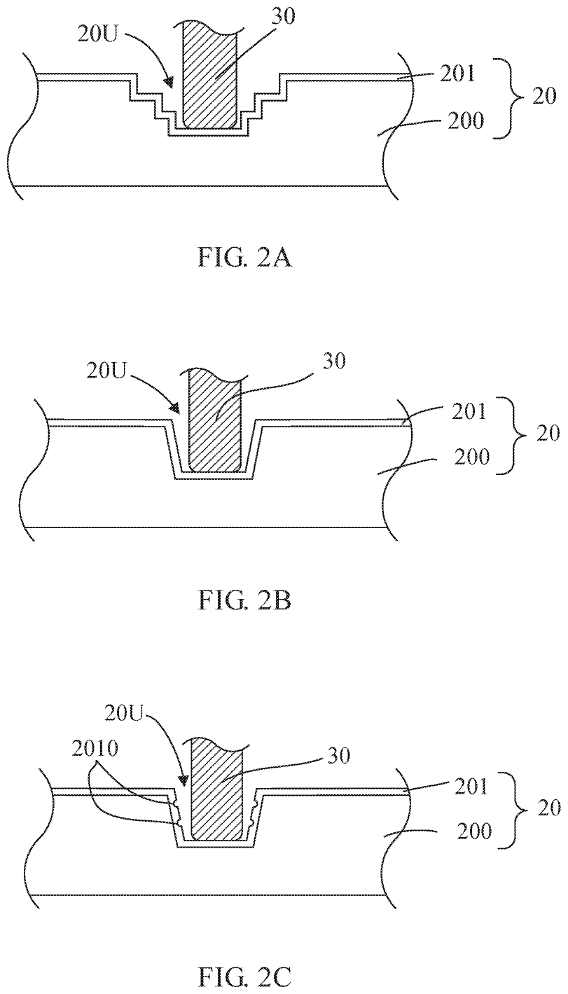

FIG. 2A is a partially cross-sectional view of a display panel according to a second embodiment of the present disclosure. For the convenience of explaining, in FIG. 2A, part of components of the display panel 1 are omitted. As shown in FIG. 2A, a hollow portion 20U has a ladder-shaped section so that sliding difficulties faced by a spacer 30 are increased, and thus each spacer 30 can be located in a position of each hollow portion 20U on a second substrate 20.

FIG. 2B is a partially cross-sectional view of a display panel according to a third embodiment of the present disclosure. For the convenience of explaining, in FIG. 2B, part of components of the display panel 1 are omitted. As shown in FIG. 2B, a section of a hollow portion 20U has a shape of a trapezoid so that sliding difficulties faced by a spacer 30 are increased, and thus each spacer 30 can be located in a position of each hollow portion 20U on a second substrate 20.

FIG. 2C is a partially cross-sectional view of a display panel according to a fourth embodiment of the present disclosure. For the convenience of explaining, in FIG. 2C, part of components of the display panel 1 are omitted. As shown in FIG. 2C, a plurality of micropores 2010 are disposed on a surface of a hollow portion 20U so that sliding difficulties faced by a spacer 30 are increased, and thus each spacer 30 can be located in a position of each hollow portion 20U on a second substrate 20.

In conclusion, the present disclosure provides a display panel mainly by disposing hollow portions on a surface of a second substrate, causing spacers not to slide and scratch an alignment layer on the second substrate and thus avoiding the occurrence of spots.

It should be understood that the application of the present disclosure is not limited by the foregoing examples. A person of ordinary skill in the art is able to make modifications or changes based on the foregoing description, and all of these modifications and changes are within the scope of the appended claims of the present disclosure.

The industrial applicability of the present disclosure is that, a display panel is mainly provided by disposing hollow portions on a surface of a second substrate, causing spacers not to slide and scratch an alignment layer on the second substrate and thus avoiding the occurrence of spots.

What is claimed is:

1. A display panel, comprising:
a first substrate;
a second substrate disposed opposite to the first substrate, wherein the second substrate comprises an alignment layer formed on a surface of the second substrate, wherein a plurality of hollow portions are disposed on the surface of the second substrate, and wherein each of the plurality of hollow portions has an arc-shaped section; and
a plurality of spacers disposed on the first substrate, wherein an end of each of the plurality of spacers, far from the first substrate, abuts against the each of the plurality of hollow portions on the second substrate respectively.

2. The display panel of claim 1, wherein the first substrate is a color filter.

3. The display panel of claim 2, wherein the second substrate is a thin-film transistor substrate.

4. A display panel, comprising:
a first substrate;
a second substrate disposed opposite to the first substrate, wherein a plurality of hollow portions are disposed on a surface of the second substrate; and
a plurality of spacers disposed on the first substrate, wherein an end of each of the plurality of spacers, far from the first substrate, abuts against each of the plurality of hollow portions on the second substrate respectively.

5. The display panel of claim 4, wherein a section of the each of the plurality of hollow portions has a shape of an arc, a semicircle, a semi-ellipse, or a trapezoid.

6. The display panel of claim 4, wherein the each of the plurality of hollow portions has a ladder-shaped section.

7. The display panel of claim 4, wherein a plurality of micropores are disposed on a surface of the each of the plurality of hollow portions.

8. The display panel of claim 4, wherein the second substrate comprises an alignment layer formed on the surface of the second substrate.

9. The display panel of claim 4, wherein the first substrate is a color filter.

10. The display panel of claim 9, wherein the second substrate is a thin-film transistor substrate.

11. The display panel of claim 8, wherein the second substrate further comprises a planarization layer, wherein the alignment layer is formed on the planarization layer, and wherein the plurality of hollow portions are located at the upper part of the planarization layer.

12. The display panel of claim 11, wherein a depth of the each of the plurality of hollow portions is not greater than a thickness of the planarization layer.
